(19) United States
(12) Patent Application Publication
(10) Pub. No.: US 2004/0053140 A1
(43) Pub. Date: Mar. 18, 2004

(54) Use of a packaging strip as a holographic data carrier

(76) Inventors: Stefan Stadler, Hamburg (DE); Stefan Roeber, Hamburg (DE); Steffen Noehte, Weinheim (DE); Jorn Leiber, Hamburg (DE); Christoph Dietrich, Heidelberg (DE); Matthias Gerspach, Dossenheim (DE)

Correspondence Address: NIXON & VANDERHYE, PC, 1100 N GLEBE ROAD, 8TH FLOOR, ARLINGTON, VA, 22201-4714, US

(21) Appl. No.: 10/433,573

(22) PCT Filed: Oct. 23, 2001
(86) PCT No.: PCT/EP01/12238

(30) Foreign Application Priority Data
Dec. 5, 2000 (DE) 100 60 235.5

(51) Int. Cl. G03H 1/02

(52) U.S. Cl. 430/1; 430/2; 359/3

(57) ABSTRACT

A packaging tape (3) which comprises a polymer film is used as a holographic data carrier. The packaging tape (3) is set up for the storage of holographic information. Holographic information can be put into the packaging tape (3) with the aid of a writing device (4), before an object (1) is packaged by using the packaging tape (3), but also afterwards.

The invention relates to the use of a packaging tape which comprises a polymer film.

Packaging tapes which contain a polymer film, whose underside is generally provided with an adhesive layer, are used to a great extent when packaging objects. The polymer film is often reinforced by a fabric inlay. A packaging tape of this kind can, for example, be wound around a carton in order to close the carton and, if appropriate, also to seal or reinforce the latter.

For logistical purposes, at present use is primarily made of bar codes in addition to conventional transport documents. In this case, for example, a label with a one-dimensional or two-dimensional bar code is stuck to a package. The bar code contains, for example, a reference number which, with the aid of electronic data processing, can be assigned further information. The direct storage capacity of bar codes is very limited, however. In the near future, the use of transponders for logistical purposes is also to be expected. Transponders have the advantage that they can be detected without free visual sight. Their storage capacity, on the other hand, is low and the costs for mass use are currently still too high.

It is an object of the invention to provide a simple and cost-effective possible way of providing an object, in particular a packaged object or its packaging, with a larger quantity of information.

This object is achieved by the use of a packaging tape according to the features of claim 1. Advantageous refinements of the invention emerge from the subclaims.

According to the invention, a packaging tape which comprises a polymer film is used as a holographic data carrier, the packaging tape being set up for the storage of holographic information. The packaging tape is preferably used for packaging objects. Other applications, for example as a label, are likewise conceivable, however. In one preferred refinement, the packaging tape has an adhesive layer, in order that it sticks to an object in a self-adhesive manner. It can also have further components, for example a fabric inlay as reinforcement.

Since the packaging tape is set up for the storage of holographic information, it is able to accommodate large quantities of data. As opposed to conventional bar codes, therefore, an object can be assigned relatively large quantities of information in a direct way. Examples of this, in the case of a package which is packaged by using the packaging tape, are the delivery address, the sender, transport documents but also, for example, safety data sheets, manuals and the like. In this way, the invention permits objects to be packaged in a rapid and cost-effective manner while saving operations, and to be provided with information for logistical purposes but also with additional information.

The holographic information is preferably stored in the form of machine-readable data pages, which are explained in more detail further below. During the use of the packaging tape, first of all an object can be packaged by using the packaging tape, and holographic information is then put into the packaging tape. Alternatively, holographic information can be put into the packaging tape first, for example after the latter has been unwound from a storage roll, in a writing device provided for this purpose, and the object is then packaged by using the packaging tape. Mixed forms are likewise conceivable, in which holographic information is written into the packaging tape before and after the packaging of the object. In the case of such applications, conventional packaging machines may be used. An additional writing device is required only to put in the holographic information. Writing devices of this type which, for example, have a laser lithograph have a relatively small volume, so that an existing packaging machine can be retrofitted with tolerable expenditure. The information to be put into the packaging tape may be matched without difficulty specifically to the given object to be packaged.

Suitable materials for the polymer film are, for example, polypropylene, polyvinyl chloride, polyester, polyethylene terephthalate (PET), polyethylene naphthalate, polymethyl pentene (PMP; also poly-2-methyl pentene) and polyimide. The polymer film preferably has a thickness which is usual in conventional packaging tapes and required for the desired strength. If only a number of limited regions of the packaging tape are set up for the storage of holographic information (see below), such regions can have their own polymer film, which is considerably thinner than the load-bearing structure of the packaging tape; in this case, however, it is also conceivable for the load-bearing structure of the packaging tape itself not to have any polymer film at all.

The polymer film can be oriented and is preferably biaxially oriented, for example by being prestressed in two mutually perpendicular directions within its plane during manufacture. This generally increases the strength of the polymer film. Furthermore, in the case of an oriented polymer film, a high energy density is stored in the film material. By means of local heating with the deposition of a relatively low quantity of energy per unit area, for example with the aid of a write beam from a writing device, a relatively high change in the material with a change in the local characteristics of the polymer film can be achieved.

Oriented polymer films are therefore particularly suitable for an advantageous refinement of the invention. In this case, the polymer film can be changed locally by heating and is set up for the storage of holographic information via the local characteristics of the polymer film. There are various possible ways of utilizing this effect.

In one possible way, the refractive index of the polymer film can be changed locally by heating, it being possible for optical phase information to be stored in the polymer film via the local optical path length, and provision being made to transilluminate the polymer film in transmission when reading out information. It is therefore possible to deposit phase information locally in the polymer film, that is to say in a region provided for the storage of a unit of information, by the refractive index in this region being changed by heating (e.g. with the aid of a write beam from a writing device). The local change in the refractive index effects a change in the optical path length of the radiation used when reading information out of the polymer film (the radiation transilluminating the polymer film in transmission). This is because the optical path length is the product of the geometric path length and the refractive index; the local phase angle of the radiation used when reading information out may therefore be influenced via a change in the refractive index, that is to say the desired holographic information may be stored as phase information. A hologram produced in this way in the polymer film of the packaging tape is accordingly a refractive phase hologram.

In another possible way, the surface structure of the polymer film can be changed locally by heating, it being possible for holographic information to be stored via the local surface structure of the polymer film. In this case, therefore, the surface structure or topography of the polymer film can be changed locally, for example by a laser beam serving as a write beam being focused onto the polymer film, preferably the surface zone of the latter, so that the light energy is absorbed there and converted into thermal energy. In particular if the laser beam is radiated in for a short time (pulsed), the material change in the polymer film leading to the local change of the surface structure remains restricted to a very small volume, because of the generally poor thermal conductivity of the polymer. If the holographic information is put into the polymer film of the packaging tape point by point, the region associated with a point typically having linear lateral dimensions of the order of magnitude of 0.5 μm to 1 μm, the vertical profile of the polymer film is typically changed by 50 nm to 500 nm, this depending in detail on the characteristics and operating conditions of the write beam and the characteristics of the packaging tape. The point grid, that is to say the central spacing between two points (“pits”), typically lies in the range from 1 μm to 2 μm. In general, it is true that shorter light wavelengths of the write beam permit a closer point grid.

The polymer film can be assigned an absorber dye which is set up to absorb, at least partly, a write beam used to input information and to output the heat produced in the process, at least partly, locally to the polymer film. An absorber dye of this type permits local heating of the polymer film sufficient to change the local characteristics of the polymer film (e.g. to change the local refractive index or the local surface structure) with a relatively low intensity of the write beam. The absorber dye can be contained in the material of the polymer film. However, it can also be arranged in a separate absorber layer, which preferably comprises a binder; mixed forms are likewise conceivable. For example, the absorber layer can comprise a thin layer (e.g. with a thickness from 0.5 μm to 5 μm) of an optically transparent polymer (e.g. of polymethyl methacrylate (PMMA) or, in the case of applications for higher temperatures, of polymethyl pentene, polyether ether ketone (PEEK) or polyether imide), which is used as a matrix or binder for the molecules of the absorber dye. The absorption maximum of the absorber dye should coincide with the light wavelength of the write beam used, in order to achieve efficient absorption. For a light wavelength of 532 nm of a write beam generated by a laser, for example dyes from the Sudan red family (diazo dyes) or (for particularly polar plastics) eosin scarlet are suitable. For the usual laser diodes having a light wavelength of 650 to 660 nm or 685 nm, green dyes, for example from the styryl family (which are usual as laser dyes), are better suited.

In an alternative refinement, the polymer film bears a dye layer comprising a dye which can be changed by exposure. In this case, the holographic information can be stored in the dye layer via the local absorption capacity. When information is read out, the dye layer is transilluminated, the absorption capacity in the dye layer, varying locally as a result of changes in the dye, affecting the radiation, which permits the reconstruction of a holographic image. The local region for the storage of a unit of information typically has linear dimensions (that is to say, for example, a side length or a diameter) of the order of magnitude of 0.5 μm to 1 μm, but other sizes are also possible.

The molecules of the dye are preferably bleached or destroyed when exposed to radiation which is used to put holographic information in. “Bleaching” is understood to mean damaging the chromophoric system of a dye molecule by means of excitation with intensive light of suitable wavelength, without destroying the basic structure of the dye molecule in the process. The dye molecule loses its colour characteristics and, given sufficient exposure to the light used for bleaching, becomes optically transparent. If, on the other hand, the basic structure of a dye molecule is also destroyed, then the change effected by the exposure is referred to as “destruction” of the dye. The light used for the exposure, that is to say to put information in, does not have to lie in the visible wavelength range.

The dye layer preferably comprises a polymer matrix, in which dye molecules are embedded. The dye molecules are preferably distributed homogeneously in the dye layer or part of the dye layer. Suitable materials for the polymer matrix are polymers or copolymers, such as polymethyl methacrylate (PMMA), polyimides, polyether imides, polymethyl pentene, polycarbonate, cycloolefinic copolymers or polyether ether ketone (PEEK). During the manufacture of the packaging tape, a polymer matrix which contains dye can be applied, for example by being doctored onto the polymer film serving as the carrier or onto a reflective layer (see below) previously applied to the polymer film.

Dyes which can be bleached easily are particularly suitable as the dyes, such as azo and diazo dyes (for example the Sudan red family). For example, in the case of dyes from the Sudan red family, information can be inputted with a write beam with a light wavelength of 532 nm. However, dyes of this kind are preferably not so unstable with respect to exposure that a bleaching process is already started by ambient light (sun, artificial illumination). If the write beam is produced with a laser, considerably higher intensities can be achieved in the dye layer than in the case of exposure by ambient light, so that dyes are available which, for the desired application, are at least largely insensitive to ambient light. The dye therefore does not have to be sensitive to light, quite the opposite of a photographic film. If, on the other hand, the dye is not to be bleached but is to be destroyed with a higher laser power, recourse can be had to a large number of dyes. In this case, the absorption maximum of the respective dye is preferably matched to the wavelength of the laser used as the write beam. Further suitable dyes are polymethine dyes, aryl methine dyes, aza[18]annulene dyes and triphenyl methane dyes.

Since it should be possible to read out the holograms from the packaging tape, that is to say the holographic information put into the packaging tape, even when the packaging tape has, for example, been stuck onto a package, it is advantageous if the packaging tape has a reflective layer which is set up to reflect light used to read out holographic information. In this case, the light is aimed at the packaging tape and reflected by the reflective layer, being modulated by the changes in the packaging tape effected in order to store holographic information. The reflected light can then be registered in a favourable geometric arrangement, in order to reconstruct a holographic image of the holographic information. The point on the packaging tape, based on its cross section, at which the reflective layer is most advantageously arranged depends on the effect which is used for the storage of holographic information. However, the reading process can also be carried out without any additional reflective layer, which may even lead to better results, depending on the application.

If optical phase information about the local optical path length is stored in the polymer film, provision is made to transilluminate the polymer film, preferably in transmission, when reading out information. In this case, the reflective layer is preferably located between the polymer film and an adhesive layer. If holographic information is stored via the local surface structure of the polymer film, the reflective layer can likewise be arranged between the polymer film and an adhesive layer; in this case, the surface structure of the polymer film is transilluminated twice when information is read out. Alternatively, the reflective layer can be arranged at the surface of the polymer film whose local structure is changed when the holographic information is put in, that is to say preferably on the top of the polymer film. If a dye layer is used, which is transilluminated in transmission when information is read out, the reflective layer is located, for example, between the polymer film and the dye layer or between an adhesive layer and the polymer film.

The holographic information to be stored can be put into the packaging tape by holographic information contained in a hologram of a stored object being calculated as a two-dimensional arrangement and a write beam from a writing device, preferably a laser lithograph, being aimed at the packaging tape and being driven in accordance with the two-dimensional arrangement in such a way that the local characteristics of the packaging tape are set in accordance with the holographic information. Since the physical processes when light is scattered at a stored object are known, for example a conventional structure for producing a hologram (in which coherent light from a laser which is scattered by an object (stored object) is brought into interference with a coherent reference beam and the interference pattern produced in the process is recorded as a hologram) can be simulated with the aid of a computer program, and the interference pattern or the modulation of the local characteristics of the packaging tape can be calculated as a two-dimensional arrangement (two-dimensional array).

As already explained further above, examples of the local characteristics of the packaging tape which are set in accordance with the holographic information are the local refractive index of the polymer film, the local surface structure of the polymer film and the local absorption capacity of a dye layer borne by the polymer film.

The resolution of a suitable laser lithograph is typically about 50,000 dpi (dots per inch). The polymer film or a dye layer borne by the polymer film can therefore be changed locally in regions or pits with a size from about 0.5 μm to 1 μm. The writing speed and other details depend, inter alia, on the parameters of the write laser (laser power, light wavelength) and the duration of the exposure, and also on the characteristics of the polymer film, of the dye layer or of any absorber dye.

The holographic information is therefore preferably put in in the form of pits of predefined size; the term “pit” here is to be understood more generally in the sense of a changed region and not restricted to its original meaning (hole or depression). In this case, the holographic information can be stored in a pit in binary encoded form. This means that, in the region of a given pit, the local characteristics of the packaging tape assume only one of two possible basic shapes (basic values). These basic shapes preferably differ considerably, in order that intermediate shapes which occur in practice and which lie close to one or the other basic shape can be assigned unambiguously to one or the other basic shape, in order to store the information reliably and unambiguously.

Alternatively, the holographic information can be stored in a pit in continuously encoded form, the local characteristics of the packaging tape being set in the pit according to a value from a predefined value range.

If, for example, the local surface structure of the polymer film is to be set, the local maximum vertical change in the surface structure in the pit is therefore selected from a predefined value range. This means that, in a given pit, the surface structure of the polymer film can assume intermediate shapes between two basic shapes, so that the maximum vertical change in the existing intermediate shape assumes a value from a predefined value range, whose limits are given by the maximum vertical changes in the two basic shapes. In this case, the information can therefore be stored “in grey stages”, so that each pit is given the information content from more than one bit. This applies correspondingly to setting the local refractive index of the polymer film or the local absorption capacity in the dye layer.

In order to read holographic information out of the packaging tape, light, preferably coherent light (e.g. from a laser), can be aimed at the packaging tape over a large area. In this case, the light is modulated by the locally varying characteristics of the packaging tape (e.g. the refractive index or the surface structure of the polymer film or the absorption capacity of the dye layer). Following reflection at the packaging tape, that is to say preferably following reflection at a reflective layer, a holographic image is registered at a distance from the packaging tape, as a reconstruction of the holographic information contained in the region registered by the light, for example with a CCD sensor which is connected to a data processing device.

The term “over a large area” is to be understood to mean an area which is considerably larger than the area of a pit. In this sense, for example an area of 1 mm² is a large area. For the scheme according to which information is deposited and read out, there are many different possibilities. It is conceivable to read out a hologram on the packaging tape all at once by the entire area of the region of the packaging tape set up as a hologram being irradiated all at once. In particular in the case of relatively large areas, however, it is advantageous to divide up the information to be stored into a number or large number of individual regions (e.g. with a respective area of 1 mm²) and to read the information at once only from a predefined individual region.

When information is read out, because of the locally varying characteristics of the packaging tape, propagation time differences occur in the light waves emerging from various points, that is to say there is substantially periodic phase modulation (which applies in particular in the case of local setting of the refractive index or of the surface structure of the polymer film) or amplitude modulation (in particular in the case of a locally varying absorption capacity of a dye layer). The region of the packaging tape covered by the light therefore acts like a diffraction grating, which deflects incident light in a defined manner. The deflected light forms an image of the stored object, which represents the reconstruction of stored holographic information.

In principle, holographic information from different types of stored objects may be used with the packaging tape. For example, the information contained in images, such as photographs, logos, scripts and the like, can be stored and read out. However, the storage of machine-readable data is particularly advantageous, since in this way, for example, the data mentioned at the beginning, such as delivery address, sender, transport documents, safety data sheets, manuals and the like, can be stored. This is carried out, for example, in the form of what are known as data pages, the holographic information contained in a hologram of a graphic bit pattern (which represents the data information) being put into the packaging tape as explained. When it is read out, a holographic image of this graphic bit pattern is produced. The information contained therein can be registered, for example, with the aid of an accurately adjusted CCD sensor and processed via associated evaluation software. For the reproduction of images in which high accuracy is not critical, in principle a simple matt disc or, for example, a camera with an LCD monitor is adequate. In the case of the holographic storage of machine-readable data, it is advantageous that the information does not have to be read out sequentially, but rather that an entire data set can be registered at once, as explained. Should the surface of the packaging tape be damaged, then, in contrast to a conventional data store, this does not lead to any loss of data, but only to an impairment of the resolution of the holographic image reconstructed when the information is read out, which is generally not a problem.

It is not necessary for the entire packaging tape to be set up for the storage of holographic information. For the purposes explained, it is generally adequate if the packaging tape merely has a number of limited regions which are in each case set up for the storage of holographic information. Using an embodiment of this type, under certain circumstances it is possible to save costs, since a conventional, cost-effective packaging tape can be used as the starting material, which is configured in a more complex way only in the limited regions, in order to permit holographic information to be written and read. Such limited regions may be produced, for example, by an absorber dye being applied with the aid of a printing process to a packaging tape of oriented polypropylene, polyvinyl chloride or polyester film.

It is also conceivable for the limited regions each to have their own piece of polymer film, on which, if appropriate, additional layers such as an absorber layer, a dye layer or a reflective layer are applied, in order to permit the storage of holographic information, for example in accordance with one of the possible ways explained in more detail above. Limited regions configured in this way can, for example, be adhesively bonded or welded onto the load-bearing structure of the packaging tape (which can comprise a polymer film but does not have to). However, it is preferred to provide a common polymer film as the polymer film for the entire packaging tape, for example a polymer film which at the same time represents the load-bearing structure of the packaging tape. On this polymer film it is then possible, for example by applying the aforementioned additional layers only in the limited regions, to provide zones in which the possibility of storing holographic information is provided.

The limited regions are preferably arranged at predefined intervals on the packaging tape. This makes it easier to put in and read out holographic information in automated systems. The limited regions can, for example, be circular with a diameter of 6 mm and can have mutual centre spacings of 40 mm in the longitudinal direction of the packaging tape.

If holographic information is to be erased from the packaging tape again, the relevant holograms are preferably destroyed with an intense write beam. In this case, the destroyed region is no longer available for the storage of new information, but this is generally unimportant since, because of the high storage density provided by holograms, there are normally still unused zones on the packaging tape into which holographic information can be put.

In the following text, the invention will be explained further using exemplary embodiments. In the drawings:

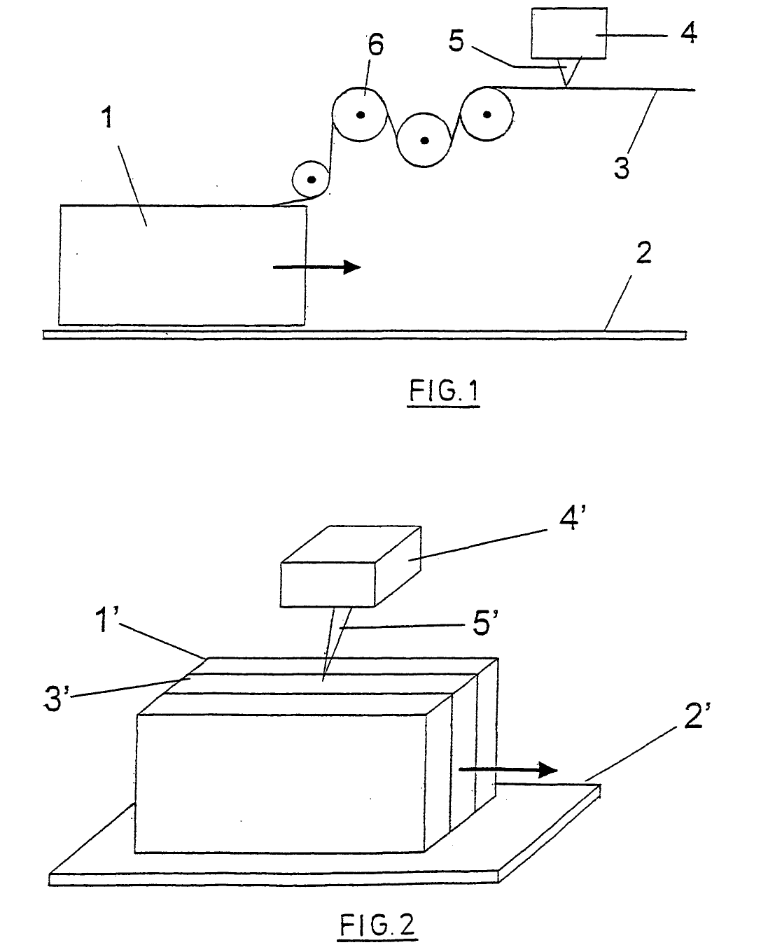

FIG. 1 shows a schematic representation which illustrates how holographic information is written into a packaging tape before the packaging tape is stuck around a package,

FIG. 2 shows a schematic illustration which illustrates how holographic information is put into a packaging tape which is already stuck around a package,

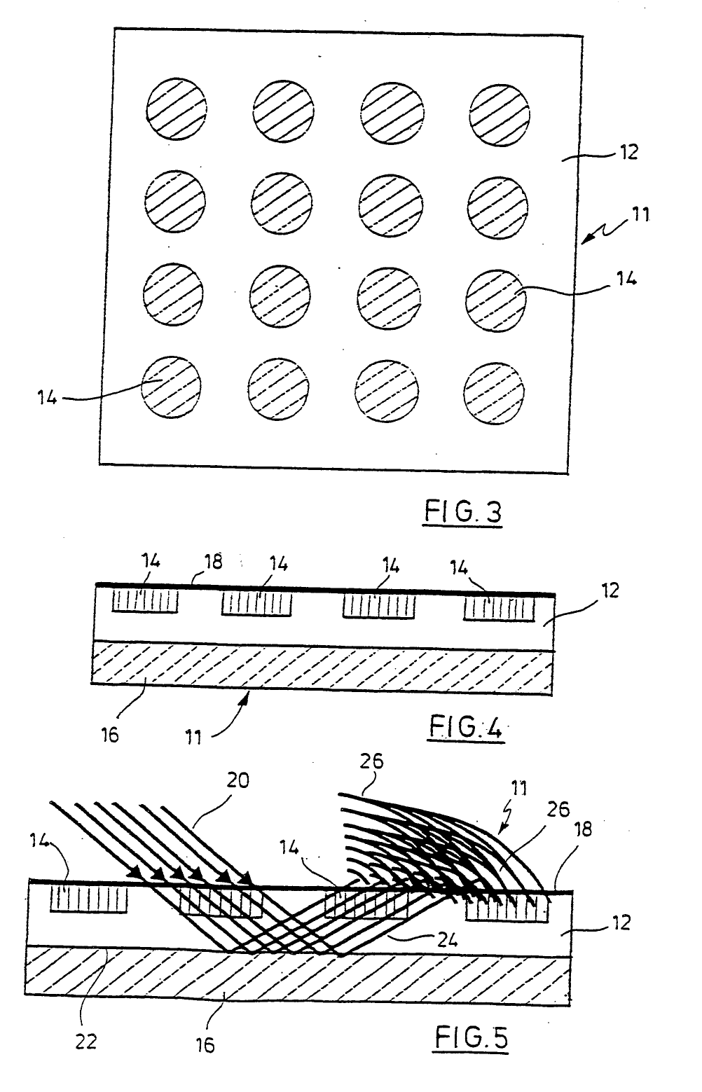

FIG. 3 shows a schematic plan view of a detail of a region of the packaging tape set up for the storage of holographic information,

FIG. 4 shows a schematic longitudinal section through a region of the packaging tape which is set up for the storage of holographic information and in which holographic information can be stored via the local optical path length in a polymer film,

FIG. 5 shows a longitudinal section according to FIG. 4, the procedures when reading information out being illustrated in a schematic way,

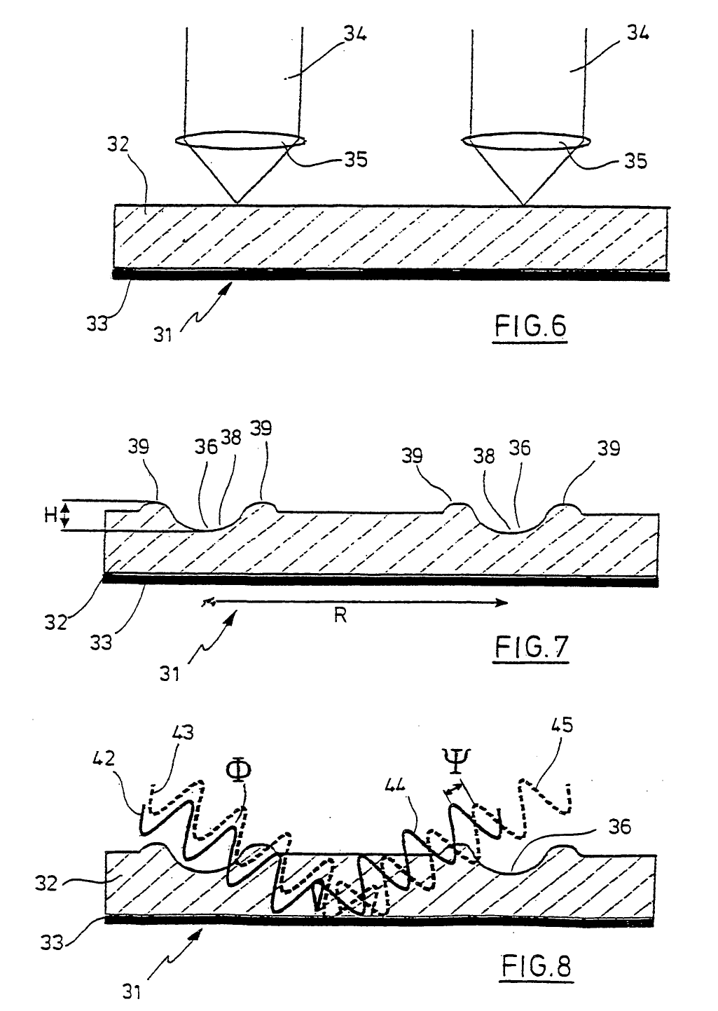

FIG. 6 shows a schematic longitudinal section through a region of the packaging tape which is set up for the storage of holographic information and in which holographic information can be stored via the local surface structure of a polymer film, information being put in with the aid of a write beam,

FIG. 7 shows a longitudinal section according to FIG. 6, after the surface structure has been changed locally in order to put the information in,

FIG. 8 shows a longitudinal section according to FIG. 7, the procedures when reading information out being illustrated in a schematic way,

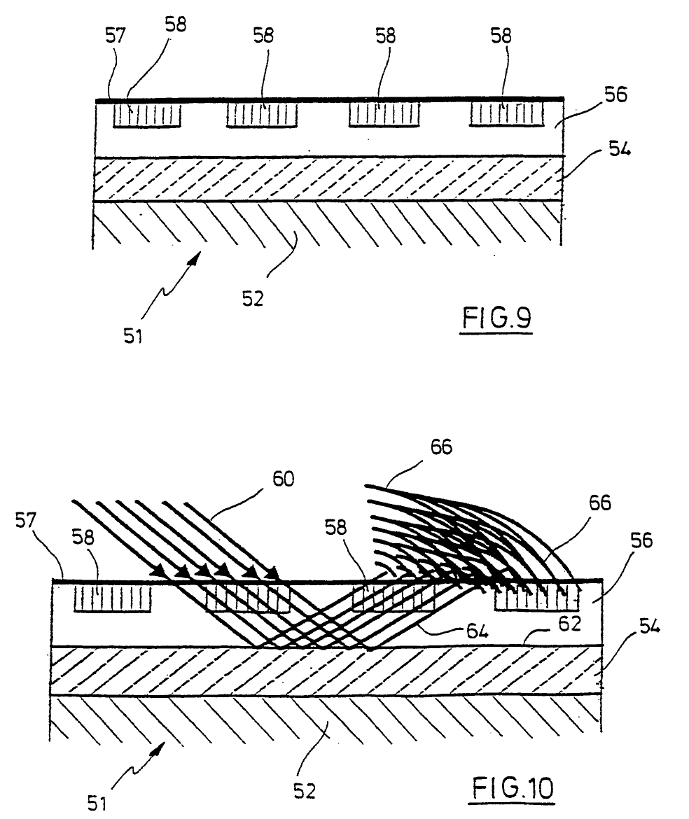

FIG. 9 shows a schematic longitudinal section through a region of the packaging tape which is set up for the storage of holographic information and in which holographic information can be stored via the local absorption capacity in a dye layer, and

FIG. 10 shows a longitudinal section according to FIG. 9, the procedures when reading information out being illustrated in a schematic way.

FIGS. 1 and 2 illustrate schematically how a package is packaged by using a packaging tape and, in the process, holographic information is put into the packaging tape, which serves as a holographic data carrier. This information can be provided for logistical purposes and, for example, can contain the delivery address and the sender and also the transport documents for the package. Since holographic data carriers have a high storage capacity, in principle further data in the form of holograms can also be stored on the packaging tape. Examples of this are safety data sheets, manuals and the like, that is to say data which have a relationship with the contents of the package. Furthermore, other data contents can also be deposited in holographic form on the packaging tape.

In FIG. 1, a package 1 is transported on a conveyor belt 2. A packaging tape 3 (“carton sealing tape”, CST) is led over the conveyor belt 2 and in the direction opposite to its running direction, with the aid of a conventional packaging apparatus. The packaging tape 3 is set up for the storage of holographic information, as explained in more detail further below. Above the packaging tape 3 there is a writing device 4, which uses a laser beam as a write beam 5 in order to put holographic information into the packaging tape 3. In the exemplary embodiment, the writing device 4 is a laser lithograph. The packaging tape 3 then passes through deflection rollers 6 and is applied to the package 1.

On its underside, the packaging tape 3 is provided with an adhesive layer, so that it adheres to the package 1 which, in the exemplary embodiment, has cartonboard packaging, and closes and seals the package 1. These steps are carried out on a conventional system. Only the writing device 4 is newly added and, because of its relatively small size, can be installed without difficulty on an existing system.

FIG. 2 shows a variant of the method sequence. In this case, a package 1′ is moved on a conveyor belt 2′. The package 1′ has already been closed with a packaging tape 3′. Arranged above the package 1′ (that is to say at a point underneath which the package 1′ moves through) is a writing device 4′ having a write beam 5′, preferably designed as a laser lithograph. Here, the holographic information is therefore put into the packaging tape 3′ after the object located in the package 1′ has been packaged by using the packaging tape 3′.

It is also conceivable to write some of the holographic information into the packaging tape 3 or 3′ before the latter is stuck onto the package 1 or 1′, and some of the holographic information thereafter.

In the exemplary embodiment, the packaging tape 3 or 3′ comprises a polymer film with a thickness of 35 μm made of biaxially oriented polypropylene. On the underside of the polymer film there is the adhesive layer, which is 20 μm thick and consists of functionalized poly(meth)acrylate. In the exemplary embodiment, the holographic information is stored in accordance with the method explained by using FIGS. 9 and 10, the upper side of the overall packaging tape being set up for the storage of holographic information. A semitransparent reflective layer of aluminium (about 10 to 20 nm thick) is therefore applied to the upper side of the polymer film, and above that there are a dye layer and a protective layer.

The packaging tape can also comprise other materials or have other dimensions or additional components, for example a fabric inlay serving for reinforcement. A fabric inlay of this type is preferably arranged underneath a polymer layer and can also be embedded in additional polymer. Further components of the packaging tape are, if appropriate, components required for the storage of holographic information (see below).

In the case of other embodiments of the packaging tape, only limited regions are provided, which are arranged at predefined intervals from one another and are in each case set up for the storage of holographic information, while the packaging tape in the zones located in between is configured as a simple packaging tape without the possibility of holographic data storage. Limited regions of this type can, for example, in each case have diameters of 5 mm and spacings of 50 mm from one another. They can, for example, in each case comprise a piece of polymer film, can have one of the configurations described below and can be adhesively bonded or welded onto a conventional packaging tape.

In the following text, various possible ways of storing holographic information with the aid of a packaging tape will be explained in more detail using examples.

FIG. 3 is a schematic plan view of a detail of a region 11 of a packaging tape which is set up for the storage of holographic information, into which region information is put. In the exemplary embodiment, the region 11 (referred to below as the “storage region”) is a limited region with its own carrier in the form of a square piece of polymer film of 8 mm side length and, together with identically constructed limited regions (storage regions), is adhesively bonded to a conventional polyester packaging tape. Alternatively, however, the entire packaging tape can also have the layer sequence explained using FIGS. 3 to 5, so that the entire packaging tape is set up for the storage of holographic information; a variant of this type is even more cost-effective under certain circumstances.

The storage region 11 has a polymer film 12 which is set up as a storage layer, at the same time serves as a carrier (and, in the case of the above mentioned variant, forms the load-bearing structure of the packaging tape) and, in the exemplary embodiment, consists of biaxially oriented polypropylene (BOPP) and has a thickness of 35 μm. The refractive index of polypropylene oriented in a bipolar fashion may be changed locally by heating, which can be used to store information, as explained further above. The polymer film 12 preferably has a thickness in the range between 10 μm and 100 μm, but other thicknesses are likewise possible. Examples of further advantageous materials for the polymer film 12 are listed further above.

In the storage region 11, information is deposited in the form of pits 14. In the region of a pit 14, the polymer film 12 has a refractive index different from that in the zones between the pits 14. Here, the term “pit” is to be understood in the sense of a changed region, that is to say more generally than in its original meaning (“hole”). In this case, the information can be stored in a pit in binary encoded form, by the refractive index assuming only two different values (it being possible for one of the two values also to coincide with the refractive index in the polymer film 12 in the zones between the pits 14). It is also possible to store the information in a pit 14 in continuously encoded form, it being possible for the refractive index within the pit 14 to assume any desired selected value from a predefined value range. In clear terms, in the case of storage in binary encoded form, a pit is “black” or “white”, while, in the case of storage in continuously encoded form, it can also assume all the grey values (graduations of the amplitude or phase) lying in between.

In the exemplary embodiment, a pit 14 has a diameter of about 0.8 μm. Shapes other than circular pits 14 are likewise possible, for example square or rectangular pits, but also other sizes. The typical dimension of a pit is preferably about 0.5 μm to 2.0 μm. FIG. 3 is therefore a highly enlarged representation and merely shows a detail from the storage region 11.

A detail from the storage region 11 is illustrated in a schematic longitudinal section in FIG. 4, specifically not to scale. It can be seen that a pit 14 does not extend over the full thickness of the polymer film 12. In practice, because of the writing method for putting in information, in which the polymer film 12 is heated in the region of a pit 14, the transition zone in the lower region of a pit 14 to the lower region of the polymer film 12 is continuous, that is to say the refractive index changes gradually in this zone and is not as sharply delimited as shown in FIG. 4.

Underneath (that is to say behind) the polymer film 12 is a reflective layer 16 which, in the exemplary embodiment, consists of aluminium. The reflective layer 16 can fulfil its function even if it is substantially thinner than the polymer film 12.

An absorber layer 18 is applied to the upper side of the polymer film 12. In the exemplary embodiment, the absorber layer 18 comprises the absorber dye Sudan red 7B, whose molecules are embedded in a matrix of an optically transparent polymer, specifically polymethyl methacrylate (PMMA). In the exemplary embodiment, the absorber layer 18 has a thickness of 0.5 μm. Sudan red 7B absorbs light particularly well in the wavelength range around 532 nm; this wavelength is suitable for a write beam from a laser lithograph for putting information into the storage region 11. Examples of other materials of the absorber layer 18 are specified further above. For example, green dyes, for example from the styryl family, are particularly suitable for light wavelengths of 635 nm or 650 to 616 nm or 685 nm, at which the laser diodes of current DVD devices operate; laser diodes of this type can be modulated directly, which makes the generation of pulses significantly simpler and cheaper. In the future, the range from 380 to 420 nm could also be of interest, when corresponding blue laser diodes can be obtained commercially and inexpensively. For this purpose, yellow absorber dyes are then preferably to be used, such as stilbenes substituted with weak donors and acceptors, donor-substituted nitrobenzenes or coumarin dyes.

The absorber layer 18 has a preferred optical density in the range from 0.2 to 1.0; however, other values are likewise conceivable. The optical density is a measure of the absorption, here based on the light wavelength of a write beam. The optical density is defined as the negative decimal logarithm of the transmission through the absorber layer, which coincides with the product of the extinction coefficient at the wavelength of the write beam used, the concentration of the absorber dye in the absorber layer 18 and the thickness of the absorber layer 18.

The absorber layer 18 makes it easier to put information into the storage region 11. This is because, if a write beam is focused onto the region of a pit 14, it is at least partly absorbed in the absorber layer 18. The heat liberated in the process is largely transferred to the polymer film 12 and thus effects a local change in the refractive index in the polymer film 12 in the region of the pit 14. However, it is possible to dispense entirely with the absorber dye if very short laser pulses are used.

In order to put information into the storage region 11, first of all phase information contained in a hologram of a stored object is calculated as a two-dimensional arrangement. This can be done as a simulation of a classical structure for producing a photographically recorded hologram, in which coherent light from a laser, following scattering at the stored object, is brought into interference with a coherent reference beam and the interference pattern produced in the process is recorded as a hologram. The two-dimensional arrangement (two-dimensional array) then contains the information which is required to drive the write beam of a laser lithograph. In the exemplary embodiment, the laser lithograph has a resolution of about 50,000 dpi (i.e. about 0.5 μm). The write beam of the laser lithograph is guided over the upper side of the storage region 11 in pulsed operation (typical pulse duration of about 1 us to 10 μs with a beam power of about 1 mW to 10 mW to put in a pit 14), in order to put the desired information sequentially into the storage region 11 (or a preselected region of the storage region 11). In the process, the write beam heats the absorber layer 18 in accordance with the two-dimensional array and in this way produces the pits 14, as explained above.

FIG. 5 illustrates a schematic way in which the information stored in the storage region 11 can be read out. For this purpose, coherent light from a laser (preferably at a wavelength which is absorbed only little by the absorber layer 18) is aimed at the upper side of the storage region 11. For clarity, of this preferably parallel-incident coherent light, only a small detail is illustrated in FIG. 5, and is designated by 20 (incident read beam). In practice, the coherent light is aimed at the polymer film 12 over a large area and covers a region of, for example, 1 mm². This is because, in order to reconstruct the stored information, the light originating from many pits 14 must be registered. The intensity of the incident read beam 20 is too weak to change the refractive index in the polymer film 12 and therefore the stored information.

The incident read beam 20, which for practical reasons strikes the surface of the storage region 11 at an angle, is reflected at the interface 22 between the polymer film 12 and the reflective layer 16, so that a reflected read beam 24 leaves the interface 22 and, in the process, passes through the pits 14. Since the local refractive index of the polymer film 12 is different, depending on the pit 14, the local optical path length is varied, so that phase shifts occur. The result of this is that spherical waves 26 containing the stored phase information leave the storage region 11 in the manner of a diffraction grating. At some distance from the storage region 11, a detector can be used to register a holographic image, which is brought about by interference between the spherical waves 26.

The expenditure required for the detector and the further processing of the registered holographic image depend on the type of stored object, as already explained further above. For the reproduction of machine-readable data (data pages), a CCD sensor connected to a data processing device is particularly suitable, while, for pure image reproduction, a simpler detector is also expedient, in particular when the image data are not to be processed further.

The storage region 11 can have additional layers apart from the layers which can be seen in FIG. 4, for example a transparent protective layer above the absorber layer 18. Underneath the reflective layer 16 in the exemplary embodiment there is an adhesive layer, with which the storage region 11 is adhesively bonded to the conventional packaging tape.

If, for example, an absorber dye that is invisible in visible light (which, for example, absorbs in the infrared) or else no absorber dye is used, or if an absorber layer is washed away after information has been put into the storage area, the storage area may be configured to be largely transparent and very inconspicuous.

Using FIGS. 6 to 8, a further possible way of storing holographic information by means of a packaging tape will be explained. In the exemplary embodiment, again limited regions or storage regions, which are fixed to a conventional packaging tape at predefined intervals, are provided to store the information. Alternatively, however, the entire packaging tape can again also comprise the sequence of layers explained using FIGS. 6 to 8, so that the entire packaging tape is set up for the storage of holographic information, in a similar way to that in the example described previously.

FIG. 6 illustrates a detail from the storage region, designated 31 here, in a schematic longitudinal sectional view. The storage region 31 has a polymer film 32 which is set up as a storage layer, in the exemplary embodiment consists of biaxially oriented polypropylene (BOPP) and has a thickness of 15 μm. On the underside of the polymer film 32 there is a reflective layer 33 of aluminium 100 nm thick. Disruptive interference effects caused by reflections at the upper side of the polymer film 32 and the reflective layer 33 can if necessary be avoided by suitable measures. If the entire packaging tape is set up for the storage of holographic information, the polymer film can be used at the same time as a load-bearing structure, and an adhesive layer is preferably arranged under the reflective layer.

Contained in the material of the polymer film 32 is an absorber dye, which absorbs light from a write beam and converts it into heat. In the exemplary embodiment, the absorber dye used is Sudan red 7B, which absorbs light particularly well in the wavelength range around 532 nm; this wavelength is suitable for a write beam from a laser lithograph for putting information into the storage region 31. Examples of other absorber dyes have already been specified further above. Alternatively, the absorber dye can also be present in a separate layer, similar to the absorber layer 18 from the example according to FIGS. 3 to 5; in this case, the absorber layer has a preferred optical density (see above) in the range from 0.2 to 1.0, but other values are likewise possible. If the absorber dye is distributed over the entire polymer film, a larger value for the optical density is recommended, in order that there is sufficient absorber dye in the surface zone of the polymer film which is to be heated in particular during the writing operation.

The absorber dye makes it easier to put information into the storage region 31. This is because, if a write beam 34 is focused onto the polymer film 32, for example with the aid of a lens 35, specifically preferably in the surface zone of the said polymer film, then the light energy of the write beam 34 is converted particularly efficiently into heat. In FIG. 6, two write beams 34 and two lenses 35 are shown, in order to illustrate the writing of information at two different locations of the polymer film 32. In practice, however, the write beam 34 preferably moves sequentially over the surface of the polymer film 32. In order to put in the information, for example a laser lithograph with a resolution of about 50,000 dpi (that is to say about 0.5 μm) is suitable. The write beam from the laser lithograph is guided over the upper side of the polymer film 32 in pulsed operation (typical pulse duration of about 1 μs to about 10 μs at a beam power of about 1 mW to about 10 mW to expose or heat a location), that is to say as a rule in two spatial directions, in order to put the desired information sequentially into the storage region 31 (or a preselected region of the storage region 31).

FIG. 7 shows the result of the action of the pulsed write beam 34. Because of the poor thermal conductivity of the material of the polymer film 32, a significant temperature increase occurs in a closely limited volume, in which the surface structure of the polymer film 32 is changed locally. In this way, a pit 36 is produced, that is to say the local region in which information is deposited. To each pit 36 there belongs a central depression 38, which is surrounded by peripheral ejected material 39. The difference in level between the lowest point of the depression 38 and the highest point of the ejected material 39, that is to say the local maximum vertical change in the surface structure in the pit 36, is designated H in FIG. 7. H typically lies in the range from 50 nm to 500 nm. The distance between the centres of two adjacent pits 36, that is to say the point grid R, preferably lies in the range from 1 μm to 2 μm. In the exemplary embodiment, a pit 36 has a diameter of about 0.8 um. Shapes other than circular pits 36 are likewise possible. The typical dimension of a pit is preferably about 0.5 μm to 1.0 μm. In plan view, the polymer film 32 with the pits 36 appears similar to the illustration in FIG. 3.

The information can be stored in a pit 36 in binary encoded form, by H assuming only two different values (one of the two values preferably being 0). It is also possible to store the information in a pit 36 in continuously encoded form, it being possible for H for a given pit 36 to assume any desired selected value from a predefined value range.

In order to put information into the storage region 31, holographic information contained in a hologram of a stored object is first of all calculated as a two-dimensional arrangement. This can be done as a simulation of a classical structure for producing a photographically recorded hologram, for example, in which coherent light from a laser, which is scattered by the stored object, is brought into interference with a coherent reference beam and the modulation pattern produced in the process is recorded as a hologram. The two-dimensional arrangement (two-dimensional array) then contains the information which is required to drive the write beam of a laser lithograph already described further above. If the write beam of the laser lithograph is guided over the upper side of the storage region 31 in pulsed operation, it heats the polymer film 32 in accordance with the two-dimensional array. In the process, the pits 36 are produced, as seen above.

FIG. 8 illustrates in a schematic way how the information stored in the storage region 31 can be read out. For this purpose, coherent light from a laser (preferably at a wavelength which is not absorbed or is absorbed only slightly by the absorber dye in the polymer film 32) is aimed at the upper side of the storage region 31. (Alternatively, a very bright LED can also be used which, under certain circumstances, even leads to more beneficial results, primarily with regard to a reduction in what is known as speckle noise.) For clarity, of this preferably parallel-incident coherent light (incident read beam), only a small detail is illustrated in FIG. 8, namely the incident light waves designated 42 and 43. In practice, the coherent light is aimed at the polymer film 32 over a large area and covers a region of, for example, 1 mm². This is because, in order to reconstruct the stored information, the light originating from many pits 36 must be registered. The intensity of the incident read beam is too weak to change the surface structure of the polymer film 32 and therefore the stored information.

The light waves 42 and 43 have a fixed phase Φ in relation to each other. For practical reasons, they strike the upper side of the polymer film 32 at an angle, pass through the polymer film 32 and are reflected at the reflective layer 33, so that reflected light waves 44 and 45 leave the reflective layer 33 and pass through the polymer film 32 again. Since the local surface structure of the polymer film 32 varies over the pits 36, a phase shift occurs, and the reflected light waves 44 and 45 emerge with a phase Ψ, as illustrated in FIG. 8. The result of this is that light waves in which phase information is contained leave the storage region 31 in many directions in the manner of a diffraction grating. At some distance from the storage region 31, a detector can be used to register a holographic image, which is brought about by interference between these light waves and represents a reconstruction of the stored information.

FIGS. 9 and 10 illustrate a further possible way of storing holographic information by means of a packaging tape. This time, in the exemplary embodiment the entire packaging tape is set up for the storage of holographic information.

In FIG. 9, a detail from the packaging tape, designated 51, is illustrated in schematic longitudinal section, specifically not to scale; holographic information has already been put in. The packaging tape 51 has a load-bearing structure 52 of a polymer film of oriented polyvinyl chloride 40 μm thick, on the underside of which there is an acrylate adhesive layer 25 μm thick or somewhat thinner (which is not shown in FIG. 9). Applied to the upper side of the load-bearing structure 52 is a reflective layer 54 of aluminium 100 nm thick.

Arranged above the reflective layer 54 is a polymer matrix, in which dye molecules are embedded, by which means a dye layer 56 is formed. In the exemplary embodiment, the polymer matrix consists of polymethyl methacrylate (PMMA) and has a thickness of 1 μm. Other thicknesses are likewise possible. The dye used in the exemplary embodiment is Sudan red in a concentration such that an optical density of 0.8 results over the thickness of the dye layer 56, provided that the dye in the dye layer 56 has not been changed by exposure. Preferred values for the optical density lie in the range from 0.2 to 1.0; other values are likewise conceivable, however. A protective layer 57 is applied to the upper side of the dye layer 56.

Information is deposited in the packaging tape 51 in the form of pits 58, the term “pit” having to be understood as previously in the sense of a localized changed region. In the region of a pit 58, the absorption capacity in the dye layer 56 is different from that in the zones between the pits 58. In this case, the information can be stored in a pit 58 in binary encoded form, by the absorption capacity assuming only two different values (it being possible for one of the two values also to coincide with the absorption capacity in the dye layer 56 in the zones between the pits 58). It is also possible to store the information in a pit 58 in continuously encoded form, it being possible for the absorption capacity within the pit 58 to assume any desired selected value from a predefined value range.

In the exemplary embodiment, a pit 58 has a diameter of about 0.8 μm. Shapes other than circular pits 58 are likewise possible, for example square or rectangular pits, but also other sizes. The typical dimension of a pit is preferably about 0.5 μm to 1.0 μm.

It can be seen that, in the exemplary embodiment, a pit 58 does not extend over the complete thickness of the dye layer 56. In practice, on account of the writing method for putting in information, in which the dye in the dye layer 56 in the region of a pit 58 is changed with the aid of a focused write beam, the transition zone in the lower region of a pit 58 to the lower region of the dye layer 56 is continuous, that is to say the absorption capacity changes gradually in this zone and is not as sharply delimited as shown in FIG. 9. This is similarly true of the lateral edges of a pit 58. The distance between the lower regions of the pits 58 and the reflective layer 54, and the thickness of the dye layer 56, are preferably set up in such a way that, when holographic information is read out, disruptive interference and superimposition effects are avoided.

In the exemplary embodiment, during the manufacture of the packaging tape 51, first of all the aluminium reflective layer 54 is vapour-deposited onto the load-bearing structure 52, then the polymer matrix with the dye of the dye layer 56 is applied by an engraved roll and finally the protective layer 57 is laminated on.

In order to put information into the packaging tape 51, in the manner similar to that before, first of all holographic information contained in a hologram of a stored object is calculated as a two-dimensional arrangement (amplitude modulation). This can be done as a simulation of a classical structure for producing a photographically recorded hologram, for example, in which coherent light from a laser, following scattering at the stored object, is brought into interference with a coherent reference beam and the interference pattern produced in the process is recorded as a hologram. The two-dimensional arrangement (two-dimensional array) then contains the information which is required to drive the write beam of a laser lithograph. In the exemplary embodiment, the laser lithograph has a resolution of about 50,000 dpi (i.e. about 0.5 μm). The write beam of the laser lithograph is guided over the dye layer 56 of the packaging tape 51 in pulsed operation (typical pulse duration of about 1 μs to 10 μs with a beam power of about 1 mW to 10 mW to put in a pit 58), in order to put the desired information sequentially into the packaging tape 51 (or a preselected region of the packaging tape 51). In the process, the write beam changes the dye in the dye layer 56 in accordance with the two-dimensional array and in this way produces the pits 58, as explained above.

FIG. 10 illustrates in a schematic way how the information stored in the packaging tape 51 can be read out. For this purpose, coherent light from a laser (preferably at a wavelength which is absorbed significantly by the dye of the dye layer 56) is aimed at the upper side of the packaging tape 51. For clarity, of this preferably parallel-incident coherent light, only a small detail is illustrated in FIG. 10, and is designated by 60 (incident read beam). In practice, the coherent light is aimed at the dye layer 56 over a large area and covers a region of, for example, 1 mm². This is because, in order to reconstruct the stored information, the light emerging from many pits 58 must be registered. The intensity of the incident read beam 60 is too weak to change the dye in the dye layer 56 and therefore the stored information.

The incident read beam 60, which for practical reasons strikes the surface of the packaging tape 51 at an angle, transilluminates the dye layer 56 and is reflected at the interface 62 between the dye layer 56 and the reflective layer 54, so that a reflected read beam 64 leaves the interface 62. In the process, the pits 58 with their different local absorption capacity are penetrated, which effects amplitude modulation with periodically different light absorption. The incident read beam 60 is thus deflected in a defined manner, with the consequence that spherical waves 66 which reproduce the stored holographic information leave the packaging tape 51 in the manner of a diffraction grating. At some distance from the packaging tape 51, a detector can be used to register a holographic image, which is brought about by the interference between the spherical waves 66. The read beam is also reflected and possibly modulated at the interface of the packaging tape 51 with respect to air (not shown in FIG. 10 for clarity), but considerably more weakly. Nevertheless, by means of suitable selection of the materials and layer thicknesses, it should be ensured that disruptive interference between the various reflected beams does not occur.

If use is made of a dye that is invisible in visible light (which, for example, absorbs in the infrared), the packaging tape can be configured to be largely transparent and very inconspicuous.

In addition to the possible ways, explained here by using examples, of storing holographic data by means of a packaging tape, a packaging tape can in principle also be used in conjunction with other holographic storage techniques.

1. Use of a packaging tape which comprises a polymer film (12; 32; 52) as a holographic data carrier, the packaging tape (3; 3′) being set up for the storage of holographic information.

2. Use according to claim 1, characterized in that an object (1; 1′) is packaged by using the packaging tape (3; 3′).

3. Use according to claim 2, characterized in that the object (1′) is packaged by using the packaging tape (3′), and holographic information is subsequently put into the packaging tape (3′).

4. Use according to claim 2 or 3, characterized in that holographic information is put into the packaging tape (3) and the object (1) is then packaged by using the packaging tape (3).

5. Use according to one of claims 1 to 4, characterized in that the polymer film (12; 32; 52) is oriented, preferably biaxially oriented.

6. Use according to one of claims 1 to 5, characterized in that the polymer film (12; 32; 52) has a material which is selected from the following group: polypropylene, polyvinyl chloride, polyester, polyethylene terephthalate, polyethylene naphthalate, polymethyl pentene, polyimide.

7. Use according to one of claims 1 to 6, characterized in that the packaging tape (3; 3′; 51) comprises an adhesive layer.

8. Use according to one of claims 1 to 7, characterized in that the polymer film (12; 32) can be changed locally by heating and is set up for the storage of holographic information via the local characteristics of the polymer film (12; 32).

9. Use according to claim 8, characterized in that the refractive index of the polymer film (12) can be changed locally by heating, it being possible for optical phase information to be stored in the polymer film (12) via the local optical path length, and provision being made to transilluminate the polymer film (12), preferably in transmission, when reading out information.

10. Use according to claim 8, characterized in that the surface structure of the polymer film (32) can be changed locally by heating, it being possible for holographic information to be stored via the local surface structure of the polymer film (32).

11. Use according to claim 9 or 10, characterized in that the polymer film (12; 32) is assigned an absorber dye which is set up to absorb, at least partly, a write beam (34) used to input information and to output the heat produced in the process, at least partly, locally to the polymer film (12; 32).

12. Use according to claim 11, characterized in that absorber dye is contained in the material of the polymer film (32).

13. Use according to claim 11 or 12, characterized in that absorber dye is arranged in a separate absorber layer (18), the absorber layer (18) preferably comprising a binder.

14. Use according to one of claims 1 to 7, characterized in that the polymer film (52) bears a dye layer (56) comprising a dye that can be changed, preferably bleached or destroyed, by exposure, it being possible for holographic information to be stored in the dye layer (56) via the local absorption capacity.

15. Use according to claim 14, characterized in that the dye layer (56) comprises a polymer matrix in which dye molecules are embedded, the polymer matrix preferably comprising at least one of the polymers or copolymers selected from the following group: polymethyl methacrylate, polyimides, polyether imides, polymethyl pentene, polycarbonate, cycloolefinic copolymer, polyether ether ketone.

16. Use according to claim 14 or 15, characterized in that the dye comprises at least one of the dyes selected from the following group: azo dyes, diazo dyes, polymethine dyes, aryl methine dyes, aza[18]annulene dyes, triphenyl methane dyes.

17. Use according to one of claims 1 to 16, characterized in that the packaging tape (3; 3′; 51) comprises a reflective layer (16; 33; 54) which is set up to reflect light used to read out holographic information.

18. Use according to one of claims 1 to 17, characterized in that, in order to put holographic information into the packaging tape (3; 3′; 11; 31; 51), holographic information contained in a hologram of a stored object is calculated as a two-dimensional arrangement, and a write beam (5; 5′; 34) from a writing device (4; 4′), preferably a laser lithograph, is aimed at the packaging tape (3; 3′; 11; 31; 51) and is driven in accordance with the two-dimensional arrangement such that the local characteristics of the packaging tape (3; 3′; 11; 31; 51) are set in accordance with the holographic information.

19. Use according to claim 18, characterized in that the holographic information is input in the form of pits (14; 36; 58) of predefined size.

20. Use according to claim 19, characterized in that the holographic information is stored in a pit (14; 36; 58) in binary encoded form.

21. Use according to claim 19, characterized in that the holographic information is stored in a pit (14; 36; 58) in continuously encoded form, the local characteristics of the packaging tape (3; 3′; 11; 31; 51) in the pit (14; 36; 58) being set in accordance with a value from a predefined value range.

22. Use according to one of claims 1 to 21, characterized in that the packaging tape (3; 3′; 11; 31; 51) comprises stored holographic information.

23. Use according to one of claims 1 to 22, characterized in that, in order to read holographic information out of the packaging tape (3; 3′; 11; 31; 51), light (20; 42, 43; 60), preferably coherent light, is aimed at the packaging tape (3; 3′; 11; 31; 51) over a large area and, following reflection at the packaging tape (3; 3′; 11; 31; 51), a holographic image is registered at a distance from the packaging tape (3; 3′; 11; 31; 51) as a reconstruction of the holographic information contained in the irradiated region.

24. Use according to claim 23, characterized in that the holographic image is registered by a CCD sensor connected to a data processing device.

25. Use according to one of claims 1 to 24, characterized in that the packaging tape (3; 3′) has a number of limited regions (11; 31) which are in each case set up for the storage of holographic information.

26. Use according to claim 25, characterized in that the limited regions (11; 31) are arranged at predefined intervals on the packaging tape (3; 3′).

27. Use according to one of claims 1 to 26, characterized in that holographic information to be erased from the packaging tape (3; 3′; 11; 31; 51) is erased by means of destruction with an intense write beam.

28. Packaging tape, characterized in that it is prepared for the use according to one of claims 1 to 27.
